(19) United States
(12) Patent Application Publication
(10) Pub. No.: US 2013/0164085 A1
(43) Pub. Date: Jun. 27, 2013

(54) SUBSOILING DEVICE INSERTING AN UNFOLDED UNDERGROUND SHEET

(71) Applicant: Jose Abs Sobrinho, Sao Paulo (BR)

(72) Inventor: Jose Abs Sobrinho, Sao Paulo (BR)

(21) Appl. No.: 13/819,472

(22) PCT Filed: Aug. 12, 2011
(86) PCT No.: PCT/BR2011/000281

§ 371 Date: Feb. 27, 2013

(30) Foreign Application Priority Data
Aug. 27, 2010 (BR) PI1003041-7

(51) Int. Cl. A01B 17/00

(52) U.S. Cl. CPC A01B 17/00; A01B 13/08
USPC 405/176

(57) ABSTRACT

An agricultural implement, more specifically a subsoiling device for treating soils with low moisture retention. The subsoiling device solves the problem of soil moisture retention by providing a layer endowed with permeability control without necessarily modifying the characteristics of the subsoil and conservation. The subsoiling device is capable of introducing, in a single operation, a foil or open sheet below the surface in a single operation, without removing the overlaying soil.

### FIELD

This disclosure pertains to the field of agricultural implements, more specifically of subsoilers for treating soils with low moisture retention, when preparing them for planting.

### BACKGROUND

Subsoilers known in the art, whether conventional or multi-purpose, are generally used in the preparation of arable land area in order to achieve suitable conditions for planting and may also be employed for controlling soil drainage or permeability.

Thus, there are integrated with state of the art subsoilers designed to: a) modify the features of topsoil revolving, disaggregating, loosening or submitting it to other processes that physically alter their own conditions, promoting softening of the subsurface structure; b) prepare the topsoil for specific crops, such as sugar cane, grains or reforestation.

The prior art comprises many publications dealing with the structural characteristics of subsoilers emphasizing their interaction with the soil, relating mostly to the assembly of the shank, fastening systems, tooth wear, security mechanisms, vibrators, hydraulic systems, fertilizer spreading devices, devices for drain maintenance, means for adjusting height and angle of attack, stabilization devices, configuration of torpedo-like devices, among others.

Known subsoilers require use of complex techniques and equipment to remove, stir, crush, compress or loosen the topsoil in order to modify its permeability.

Thus, the subsoilers known in the prior art are, in general, agricultural implements provided with a shank having the purpose of the breakdown or disintegration of the soil.

However, there is no known agricultural implement subsoiler able to promote the water retention and/or humidity control required for planting the crop to be developed, other than by disaggregating or loosening the topsoil.

In fact, a survey on the state of the art, performed by the inventor found no subsoiler provided with means for the insertion of a sheet in the soil below the cultivation layer, as proposed herein and described below.

### SUMMARY

This application describes an innovative solution that fashions a flat underground duct inside which a flat sheet is extended, the sheet having the purpose of retaining soil moisture above it, without the need to change the physical properties of the soil.

A subsoiling device is described which solves the problem of soil moisture retention and conservation.

In addition, a device is described that is capable of minimizing loss of fertilizer as well as other soil nutrients.

In addition, a layer is described that is endowed with permeability control without necessarily modifying the characteristics of the subsoil.

In one embodiment, a subsoiling device is provided with means for inserting an underground flat sheet.

In another embodiment, the subsoiler device is made of steel and is capable of introducing, in a single operation, a foil or open sheet about 40 cm wide, at an approximate depth of 0.5 m below the surface without removing the overlaying soil.

The described subsoiling device relates to the need for soil reclamation degraded by lack of moisture, such as sandy soils, semi-arid or desert, and the need to reduce irrigation of yearly cycle crops by introducing an open sheet below the plant roots.

The described subsoiling device provides large operational flexibility, enabling it to be installed directly at the fixing points of tractors or other implements, such as, for example, tensile bars.

In another embodiment, the subsoiling device comprises a feeder roll of coiled sheet folded lengthwise, a column or guiding shaft, an unfolding element and an expander wing.

### DRAWINGS

FIG. 1 is a schematic perspective view of the subsoiling device.

FIG. 2 is a schematic perspective view of the ramming torpedo-like device or tip of the subsoiling device, which shows the striking blade (1a) and the torpedo-like device.

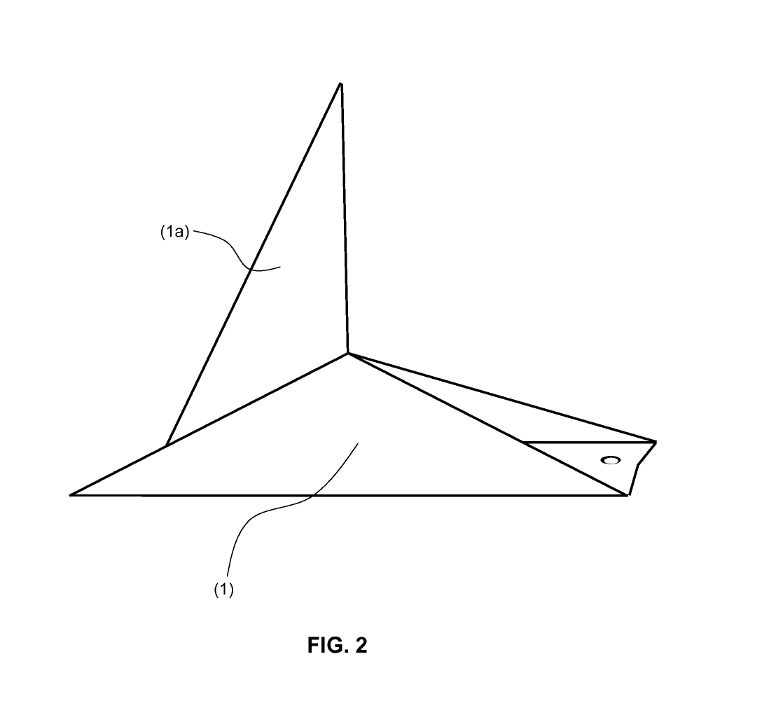

FIG. 3 is a schematic perspective view detailing the operation of the unfolding element (9)—comprising a horizontal angled bar—placed inside the soil loosening wing (8).

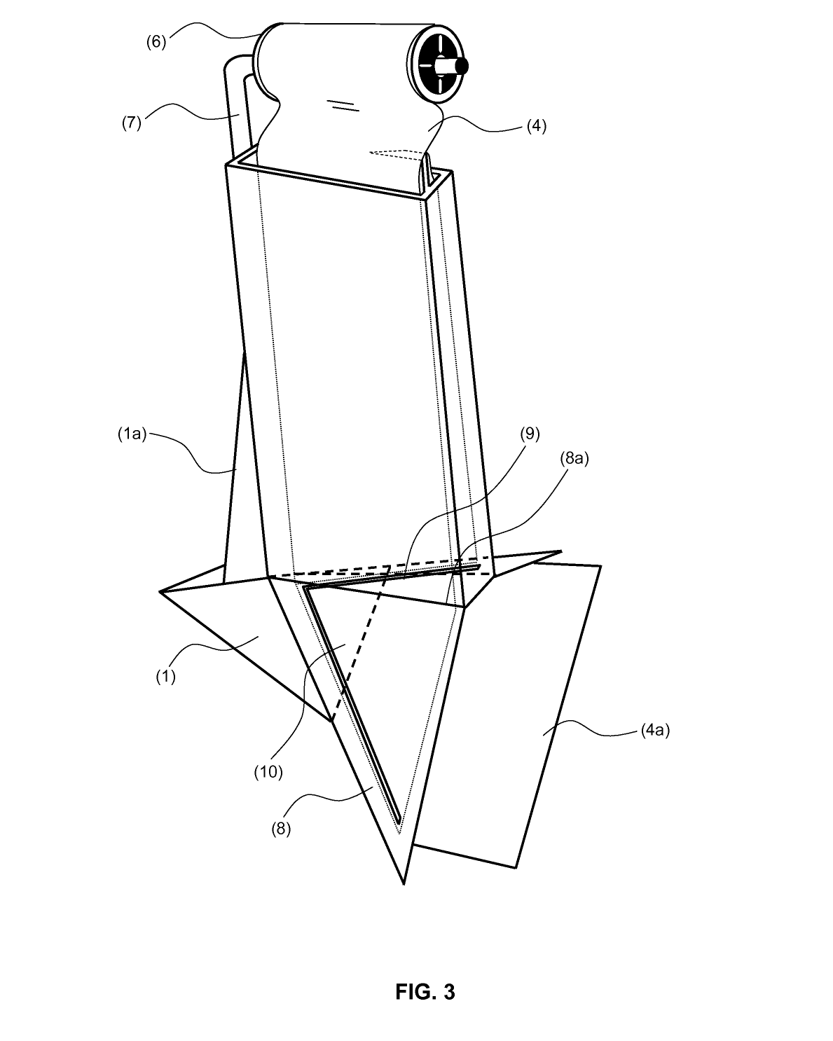

FIG. 4 is a schematic perspective view of the top of the guiding shaft (2) showing the coil of lengthwise folded sheet (6) (having a width L), the longitudinal cutting blade element (3) thereof and the entry of said sheet into the guide shaft.

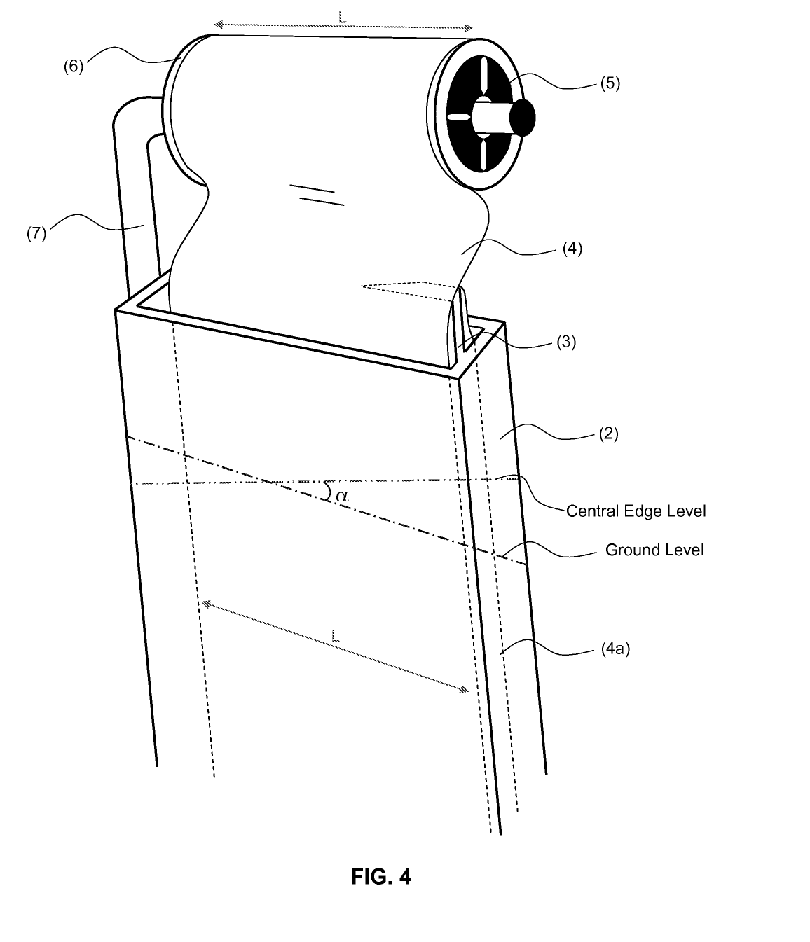

FIG. 5 is a schematic perspective view of the lower part of the guiding shaft (2) detailing the soil loosening wing (8), as well as showing the action of unfolding element (9).

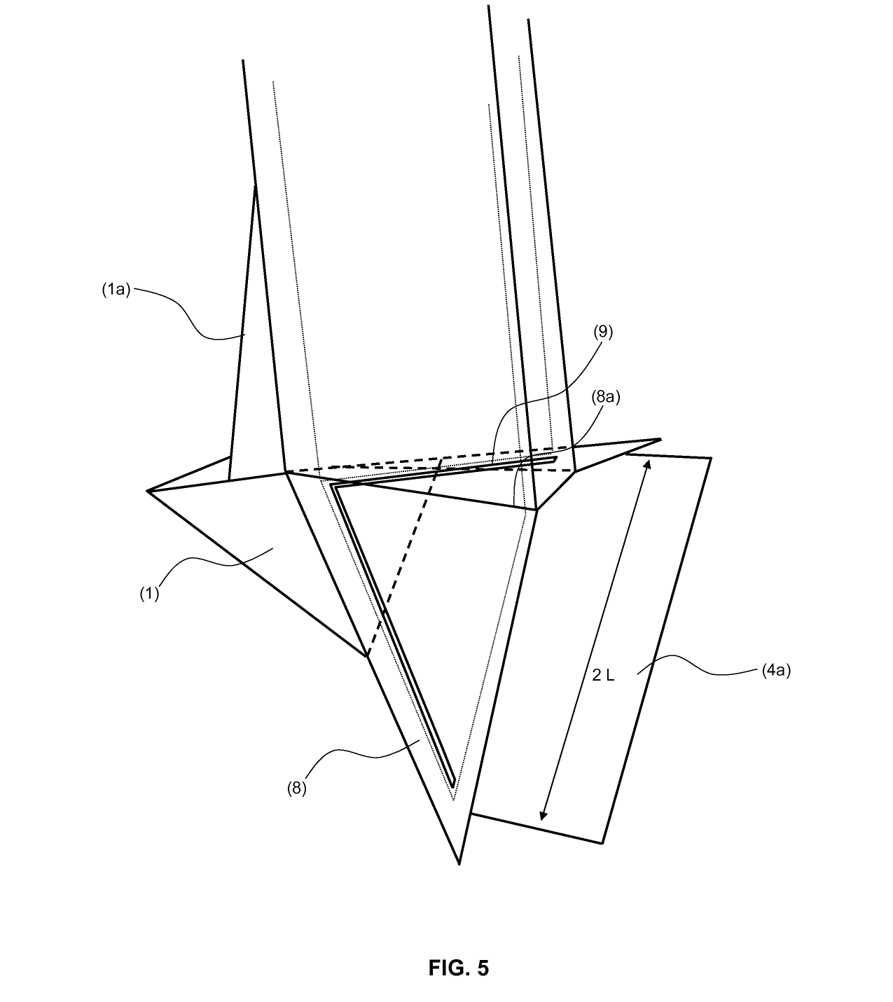

### DETAILED DESCRIPTION

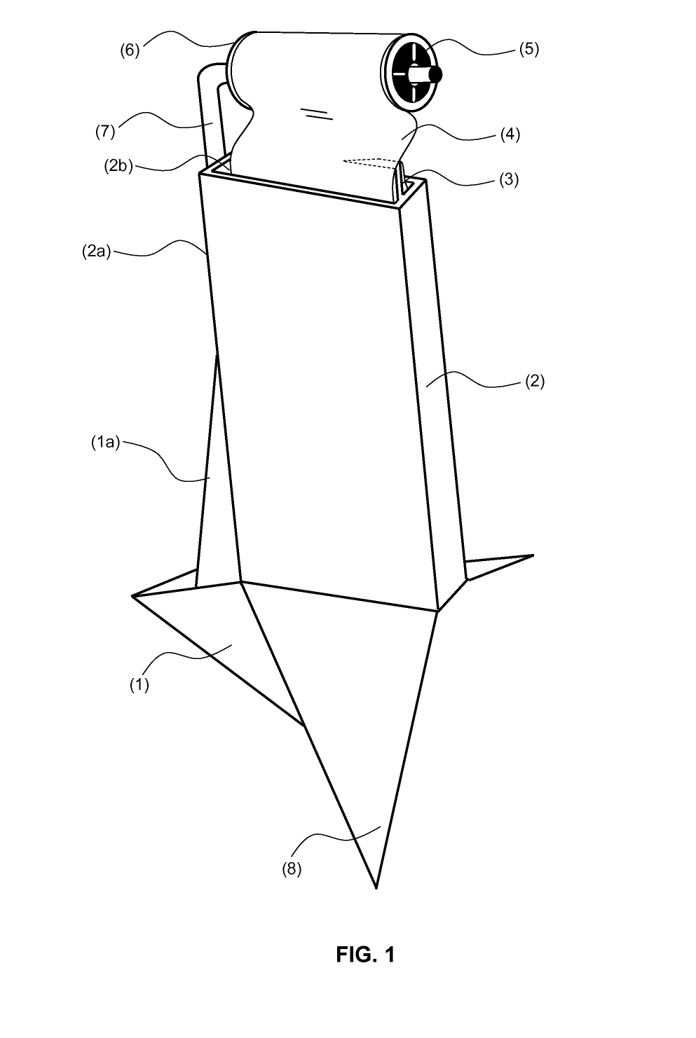

According to the embodiment shown in FIG. 1, the subsoiling device comprises a column or guiding shaft (2), whose forward side (2a), extending to the lower front edge thereof is integral to a torpedo-like device (1) and a striking blade (1a), which are removable and replaceable when worn out.

The guiding shaft (2) has a horizontal cross-section shaped as a hollow flattened rectangle (2b), serving as a duct into which the lengthwise folded sheet (4) supplied by the coil (6) is introduced and moves. The coil (6) rotates around a supporting means (7) in which it is installed and held by a fetter (5).

The sheet being introduced by the device may comprise plastic material, woven or non-woven fabric or mat.

In case the folded sheet of width L is furnished without any longitudinal slot, a cutting element (3) or blade can be installed between the coil output of and the entry of the guiding shaft.

At the lower end of the guiding shaft (2), immediately behind the torpedo-like device (1), there is located a soil loosening element or wing expander (8), inside which the sheet unfolding element (9) is installed, so that the sheet (4a), after being unfolded and having a width of 2L is extended and introduced through the outlet of the expander (8) into the subsoiled gap opened by the torpedo-like device (1) and further shaped by the wings of the expander (8).

The central edge (8a) of the expander wing (8) is inclined in relation to the ground level as well as the level of the lower base (10) of the torpedo-like device (1) by an angle (a) which corresponds to the maximum angle of soil loosening, and equals the angle formed between the ground level and the central edge.

1-4. (canceled)

5. Subsoiling device that inserts an unfolded underground sheet, comprising at least one supporting means for a coil carrying a lengthwise folded sheet, a guiding shaft or column, a torpedo-like device and a striking blade, an expander or soil loosening wing and an unfolding element.

6. The subsoiling device of claim 5, further comprising a cutting element for cutting said folded sheet.

7. The subsoiling device of claim 5, wherein the wing includes a central edge that is inclined relative to the ground level as well as the level of a lower base of the torpedo-like device by an angle a, which corresponds to an angle of maximum soil loosening.

8. The subsoiling device of claim 5, further comprising two triangles inside the expander wing which guide the folded sheet to the unfolding element that includes an angled horizontal bar which completes the action of unfolding said sheet.
